(19) United States
(12) Patent Application Publication
(10) Pub. No.: US 2007/0095600 A1
(43) Pub. Date: May 3, 2007

(54) Belt-type transmission and electric power steering apparatus having the same

(75) Inventors: Heegwon Jo, Wonju-si (KR); Joo Namgung, Wonju-si (KR); Jungyu Song, Seongnam-si (KR)

Correspondence Address: LAHIVE & COCKFIELD, LLP, ONE POST OFFICE SQUARE, BOSTON, MA, 02109-2127, US

(73) Assignee: Mando Corporation, Pyeongtaek-si (KR)

(21) Appl. No.: 11/311,722

(22) Filed: Dec. 19, 2005

(30) Foreign Application Priority Data
Oct. 19, 2005 (KR) 2005-98474

(51) Int. Cl. B62D 5/04

(52) U.S. Cl. 180/444

(57) ABSTRACT

The present invention relates to a belt-type transmission. In the belt-type transmission, a rotatable drive shaft is coupled with a drive pulley, and a rotatable driven shaft is spaced from the drive shaft at a predetermined distance. A driven pulley is coupled with the driven shaft, the drive shaft is connected to the driven shaft by a belt, and a tensioner is arranged inside and in contact with the belt. With the invention, the tensioner provided inside the belt contacts the inner periphery of the belt without additional support structure in order to adjust belt tension. This as a result can advantageously reduce the number of parts and simplify manufacturing process thereby saving manufacturing cost.

### RELATED APPLICATION

This application claims priority to Korean Patent Application No. 2005-98474 filed on Oct. 19, 2005.

### FIELD OF THE INVENTION

The present invention relates to a belt-type transmission and an electric power steering apparatus of an automobile having the same. More particularly, the present invention relates to a belt-type transmission having a tensioner arranged inside and in contact with a belt, which connects a drive shaft to a driven shaft, in order to adjust the tension of the belt without additional support structure for the tensioner, thereby reducing the number of parts and saving manufacturing cost, as well as an electric power steering apparatus of an automobile having the same.

### BACKGROUND OF THE INVENTION

Although hydraulic power steering apparatuses which function by way of a hydraulic pump are generally used the a power steering apparatus of an automobile, the use of electric power steering apparatuses which function by way of an electric motor has been gradually on the rise since the 1990s.

A conventional hydraulic power steering apparatus has a hydraulic pump or a steering power source actuated by an engine, and thus consumes energy incessantly, irrespective of the rotation of a steering wheel. In an electric power steering apparatus, an electric motor supplies steering power in proportion to steering torque, when it is generated by the rotation of a steering wheel. Accordingly, the use of the electric power steering apparatus can enhance energy efficiency when it is used instead of the hydraulic power steering apparatus.

FIG. 1 is a diagram of a conventional electric power steering apparatus of an automobile.

As shown in FIG. 1, the electric power steering apparatus of an automobile generally includes a steering system 100 starting from a steering wheel 101 to both wheels 108, as well as a steering power mechanism 120 for supplying steering power to the steering system 100.

The steering system 100 includes a steering shaft 102 with the top connected to the steering wheel 101, such that the steering shaft 102 can be rotated along with the steering wheel 101. The steering shaft 102 is also connected at the bottom to a pinion shaft 104 via a pair of universal joints 103. The pinion shaft 104 is connected to a rack bar 109 via a rack-pinion mechanism 105, and both ends of the rack bar 109 are connected to the wheels 108 of the vehicle via tie rods 106 and knuckle arms 107.

The rack-pinion mechanism 105 includes a pinion gear 111 and a rack gear 112 meshed with each other, in which the pinion gear 111 is provided at the bottom of the pinion shaft 104 and the rack gear 112 is formed on the rack bar 109. The rack-pinion mechanism 105 converts the rotation of the pinion shaft 104 into the linear movement of the rack bar 109. Accordingly, when a driver manipulates the steering wheel 101, the pinion shaft 104 is rotated giving linear movement to the rack bar 109, which in turn steers the wheels 108 via the tie rods 106 and the knuckle arms 107.

The steering power mechanism 120 includes a torque sensor 121 for the detection of steering torque applied to the steering wheel by a driver. The torque sensor produces an electric signal in proportion to the detected steering torque. The steering power mechanism 120 also includes an Electronic Control Unit (ECU) 123 for generating a control signal in response to the electric signal from the torque sensor 121; a motor for generating steering power in response to the control signal from the ECM 123; and a belt-type transmission 140 for transmitting steering power from the motor 130 to the rack bar 109 via a belt.

Accordingly, the electric power steering apparatus is constructed so that the steering torque generated by the rotation of the steering wheel 101 is delivered to the rack bar 109 through the rack-pinion mechanism 105; and the steering power generated by the motor 130 in response to the steering torque is delivered to the rack bar 109 via the belt-type transmission 140. That is, the steering torque generated by the steering system 100 is combined with the steering power generated by the motor 130 to make the rack bar 109 move along the axis.

FIG. 2 is a side-elevational view of a conventional electric power steering apparatus of an automobile, the illustration is partially in cross-section.

As shown in FIG. 2, the conventional electric power steering apparatus of an automobile includes a rack bar 109 extended across the vehicle with a rack gear formed on the outer periphery thereof, a pinion shaft 104 having a pinion gear meshed with the rack gear, a ball screw 210 having a ball nut 204 meshed with the ball screw 203 via balls 201, a belt-type transmission 140 connecting the ball nut 205 to a motor shaft 221 and a motor 130.

The pinion shaft 104 is connected to a steering wheel via a steering shaft, and the rack bar 109, having a predetermined length of screw formed on the outer periphery, is received in a rack housing 223. Furthermore, the rack housing 223 includes a first housing 225 in the rack gear side and a second housing 227 in the motor side.

The belt-type transmission 140 includes a belt for connecting the motor shaft 221 with the ball nut 205. With the belt-type transmission 140, steering power is generated by the motor 130 in proportion to steering torque applied to the steering wheel, and then is transmitted to the rack bar 109 via the ball nut 205.

The belt-type transmission 140 is advantageous as it prevents any vibration or impact of the rack bar 109 from directly propagating to the motor 130. However, as a drawback, change in belt tension caused by abrasion of the belt or pulley creates vibration in the belt, which in turn propagates to an automobile body making noises.

As an approach to overcome such a trouble in the art, a tensioner T which abuts against the outer surface of a belt is installed and adjusts the belt tension as shown in FIG. 3.

The tensioner T of the prior art includes a support protrusion 301 projected from a motor housing, a first support shaft 303 extended through the support protrusion 301, a tensioner pulley 305 spaced from the support protrusion 301 at a predetermined distance, a second support protrusion 307 extended through the tensioner pulley 305, a swing arm 309 connecting the first support shaft 303 to the second support shaft 307 and a torsion spring 311 pushing against the swing arm 309 in one direction.

The conventional tensioner T of this construction adjusts the tension of a belt 302 with the torsion spring 311, which applies spring force to the swing arm 309 to push against the belt 302 from outside to inside.

However, there is a disadvantage in that the conventional approach needs a number of additional parts for the tensioner T, which complicates the fabrication process, and results in the increase of manufacturing cost.

### SUMMARY OF THE INVENTION

Accordingly, the present invention has been made to solve the above-mentioned problems occurring in the prior art, and an object of the present invention is to arrange a tensioner inside and in contact with a belt in order to adjust the tension of the belt without the requirement of an additional support structure for the tensioner, thereby reducing the number of parts, simplifying the manufacturing process, and saving on manufacturing cost.

In order to accomplish this object, the invention provides a belt-type transmission including a rotatable drive shaft; a drive pulley coupled with the drive shaft; a rotatable driven shaft spaced from the drive shaft at a predetermined distance; a driven pulley coupled with the driven shaft; a belt connecting the drive shaft to the driven shaft; and a tensioner arranged inside and in contact with the belt.

In order to accomplish this object, the invention also provides an electric power steering apparatus of an automobile including a pinion shaft connected to a steering wheel of the vehicle, and having a pinion gear formed on one end; a rack bar connected to both wheels of the vehicle, and having a rack gear formed in one end part to mesh with the pinion gear and a ball screw formed in the other end part; a motor for generating steering power in proportion to steering torque generated by the steering wheel; a motor pulley coupled with a motor shaft of the motor; a ball nut meshing with the ball screw of the rack bar via a ball; a ball nut pulley provided on an outer periphery of the ball nut; a belt connecting the motor pulley to the ball nut pulley; and a tensioner arranged inside and in contact with the belt.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram of a conventional electric power steering apparatus of an automobile;

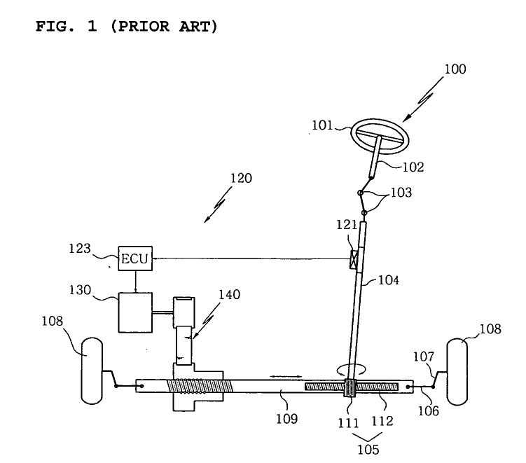

FIG. 2 is a side-elevational view of a conventional electric power steering apparatus of an automobile, illustrating it partially in cross-section;

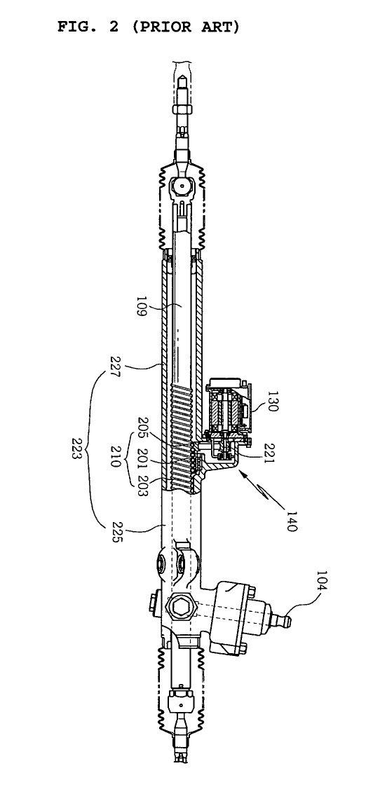

FIG. 3 is a cross-sectional view of a conventional tensioner;

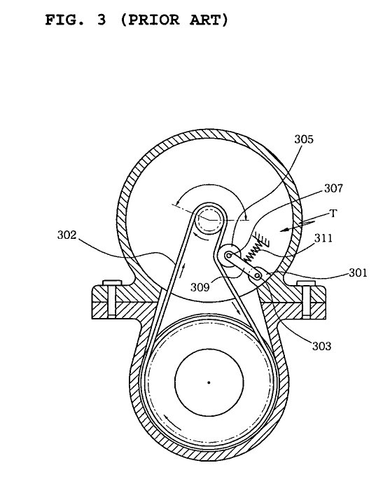

FIG. 4 is a perspective view of a belt-type transmission according to a first embodiment of the invention;

FIG. 5 is a front elevational view of the belt-type transmission shown in FIG. 4;

FIG. 6a is a diagram of an electric power steering apparatus of an automobile according to a second embodiment of the invention;

FIG. 6b is a magnified view of the electric power steering apparatus shown in FIG. 6a, whose illustration is partially in cross section; and

FIG. 7 is a cross-sectional view taken along the line A-A′ in FIG. 6b.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components throughout, and detailed description of well-known functions or components will be omitted since they may unnecessarily obscure the understanding of the invention.

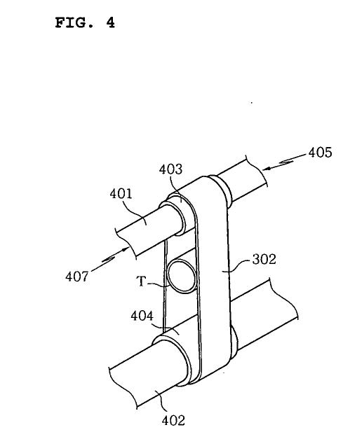

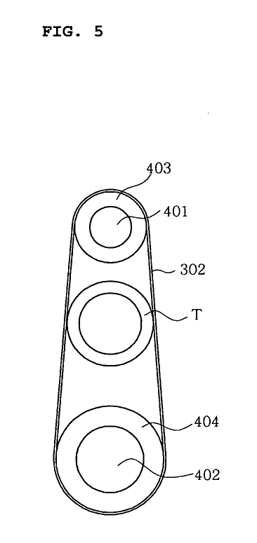

FIG. 4 is a perspective view of a belt-type transmission according to a first embodiment of the invention, and FIG. 5 is a front elevational view of the belt-type transmission shown in FIG. 4.

As shown in FIGS. 4 and 5, the belt-type electric power transmission according to the first embodiment of the invention includes a rotatable drive shaft 401, a drive pulley 403 coupled with the drive shaft 401, a rotatable driven shaft 402 spaced from the drive shaft 401 to a predetermined distance, a driven pulley 404 coupled with the driven shaft 402, a belt 302 connecting the drive shaft 401 to the driven shaft 402 and a tensioner T abutting against the inner periphery of the belt 302.

The drive shaft 401 is a cylindrical rotary shaft having a predetermined diameter, which delivers input rotational force to the driven shaft 402. An actuator such as a motor is connected to the input side 405 of the drive shaft 401 to rotate the drive shaft 401.

The drive pulley 403 is configured to surround the outer periphery of the output side 407 of the rotary shaft 401, and the belt 302 moves in contact with the outer periphery of the drive pulley 403 to transmit rotational force from the drive shaft 401 to the driven shaft 402. The drive pulley 403 may be provided integral to the drive shaft 401, and protrusions may be formed on the outer periphery of the drive pulley 403 and the inner periphery of the belt 302 so that the belt 302 can have secure contact with the drive pulley 403.

The driven shaft 402 functions to output rotational force delivered from the drive shaft 401. The driven shaft 402 is spaced from the drive shaft 401 at a predetermined distance to receive rotational force from the drive shaft 401.

The driven pulley 404 is configured to surround the outer periphery of the driven shaft 402, and serves to deliver rotational force from the belt 302 to the driven shaft 402 as the belt 302 connected to the drive shaft 401 moves in contact with the outer periphery of the driven pulley 404.

The belt 302 connects the drive shaft 401 to the driven shaft 402 to deliver rotational force from the drive shaft 401 to the driven shaft 402. The belt 302 may be provided by one or more, and made of various materials such as metal and plastic. The belt 302 may also be provided on the inner periphery with protrusions that mesh with protrusions of the drive shaft 401 and/or the driven shaft 402.

The tensioner T has a cylindrical configuration, in contact with the inner periphery of the belt 302. The tensioner T may also be made hollow to reduce its weight. Preferably, the tensioner T has a diameter larger than the width of the belt 302 without making inside-contact with the tensioner T (herein the term “inside-contact” means that the tensioner T is arranged inside and in contact with the belt 302), such that the tensioner T installed inside the belt 302 can push against the inner periphery of the belt 302 to make the belt 302 tight.

As installed to contact the inner periphery of the belt 302, the tensioner T can maintain a fixed position at all times owing to rotational force from both sides of the belt 302 that move in opposite direction. As a result, the tensioner T of this invention does not need additional support structure unlike conventional tensioners which are configured to contact the outside surface of the belt. Therefore, the invention can advantageously reduce the number of parts and simplify the manufacturing process, thereby saving manufacturing cost.

The tensioner T may also be made of elastic material such as plastic in order to cope with the loosening of the belt owing to the abrasion of the inner periphery of the belt 302 or the outer periphery of the tensioner T. Then, even though the belt 302 loosens owing to the abrasion, the elastic force of the tensioner T originating from its elasticity pushes the belt 302 outward so that the belt 302 can maintain its tension.

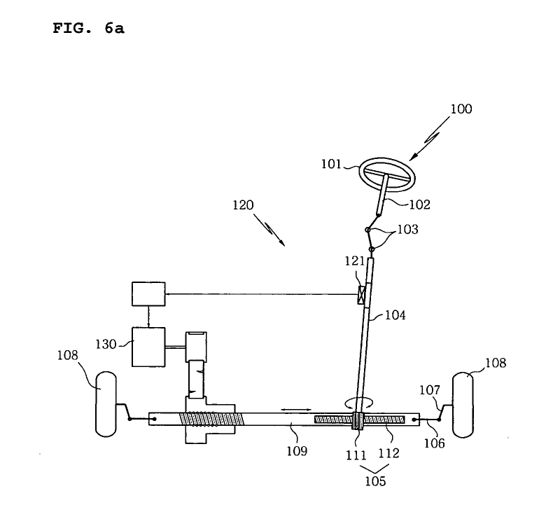

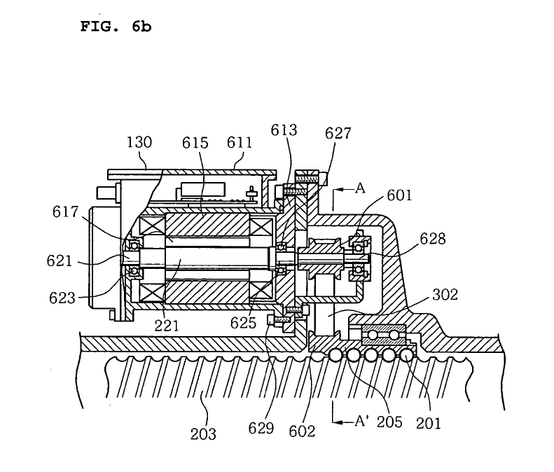

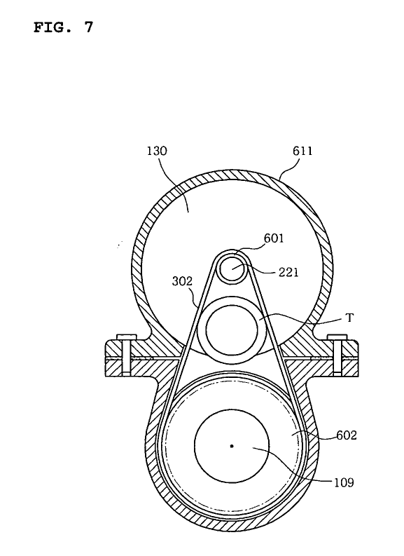

FIG. 6a is a diagram of an electric power steering apparatus of an automobile according to a second embodiment of the invention, FIG. 6b is a magnified view of the electric power steering apparatus shown in FIG. 6a, whose illustration is partially in cross section, and FIG. 7 is a cross-sectional view taken along the line A-A′ in FIG. 6b.

As shown in FIGS. 6a, 6b and 7, the electric power steering apparatus of an automobile according to the second embodiment of the invention includes a steering wheel 101 of an automobile, a pinion shaft 104 connected to the steering wheel 101, having a pinion gear 111 formed at the bottom thereof, a rack bar 109 connected to both wheels 108 and having a rack gear 112, which is formed at one part thereof and meshed with the pinion gear 111, a motor 130 for generating steering power in proportion to steering torque generated by the steering wheel 101, a motor pulley 601 coupled with the motor shaft 221, a ball nut 205 meshed with a ball screw 203 of the back bar 109 via balls 201, a ball nut pulley 602 arranged on the outer periphery of the ball nut 205, a belt 302 connecting a motor pulley 601 to a ball nut pulley 602 and a tensioner T contacting the inner periphery of the belt 302.

The pinion shaft 104 is connected to the steering wheel 101 via a steering shaft 102, and the pinion gear 111 is formed at the bottom of the pinion shaft 104.

The rack bar 109 is received in a rack housing, and connected at both ends to wheels 108 via tie rods 106 and knuckle arms 107. The rack gear 112 is formed on one part of the rack bar 109, and is meshed with the pinion gear 111. Also, seals for preventing the leakage of lubricant are provided at predetermined portions of the rack bar 109 inside from the both ends.

The rack bar 109 receives, at one side, power from the motor shaft 221 via the belt 302. In the outer periphery at the other side of the rack bar 109, a spiral groove is extended to a predetermined length, forming the ball screw 203.

The ball nut 205 meshes with the ball screw 203 via the balls 201, surrounding the outer periphery of the rack bar 109.

The ball nut pulley 602 is arranged on the outer periphery of the ball nut 205, connecting the belt 302 to the ball nut 205. The ball nut pulley 602 may also be made integral with the ball nut 205. Furthermore, protrusions may be formed on the outer periphery of the ball nut pulley 602.

The motor 130 includes a motor housing 611, a cover 613 that closes an opened end of the motor housing 611, a cylindrical stator 615 received in the motor housing 611, a rotor 617 arranged inside the stator 615 and the motor shaft 221 which is coupled integrally with the rotor 617.

The motor shaft 221 is arranged to be parallel with the rack bar 109, with a left end 621 rotatably supported by a first bearing 623 installed in the motor housing 611 and a middle part rotatably supported by a second bearing 627 installed in the cover 613. The cover 613 is also coupled with the motor housing 611 via bolts 629.

The motor pulley 601 is arranged on a right end 628 of the motor shaft 221 and the belt 302 is connected to the motor pulley 601 so that steering power generated by the motor 130 can be transmitted to the rack bar 109. The motor pulley 601 may be made integral with the motor shaft 221. Furthermore, protrusions may be formed on the outer periphery of the motor pulley 601.

The belt 302 connects the motor pulley 601 to the ball nut pulley 602 to transmit steering power from the motor 130 to the rack bar 109. If necessary, protrusions may be formed on the inner periphery of the belt 302 to mesh with protrusions formed on the outer periphery of the motor pulley 601 or the ball nut pulley 602 so that the belt 302 can be driven in tight contact with the motor pulley 601 or the ball nut pulley 602.

The tensioner T contacts the inner periphery of the belt 302 as in the first embodiment in order to push the belt 302 outward so that the belt 302 can maintain its tension.

Since other components have the same construction and operation as those of the first embodiment, the same reference signs are used to designate the same or similar components without detailed description thereof.

According to the present invention as described hereinbefore, the tensioner is provided inside and in contact with the belt without additional support structure in order to adjust belt tension. This as a result can advantageously reduce the number of parts and simplify manufacturing process, thereby saving manufacturing cost.

It is to be understood that while the present invention has been illustrated and described in relation to the preferred embodiments, such embodiments are illustrative only and that the present invention is in no event to be limited thereto. Rather, it is contemplated that modifications and variations embodying the principles of the present invention will no doubt occur to those skilled in the art. It is therefore contemplated and intended that the invention shall extend to all such modifications and variations and their equivalents as may incorporate the broad principles of this invention within the full spirit and scope of the claims appended hereto.

What is claimed is:

1. A belt-type transmission comprising:
a rotatable drive shaft;
a drive pulley coupled with the drive shaft;
a rotatable driven shaft spaced from the drive shaft at a predetermined distance;
a driven pulley coupled with the driven shaft;
a belt connecting the drive shaft to the driven shaft; and
a tensioner arranged inside and in contact with the belt.

2. The belt-type transmission according to claim 1, wherein the drive pulley has protrusions on an outer periphery.

3. The belt-type transmission according to claim 2, wherein the driven pulley has protrusions on an outer periphery, the protrusions of the driven pulley being configured in an identical way to the protrusions of the drive pulley.

4. The belt-type transmission according to claim 3, wherein the belt has protrusions on an inner periphery, meshing with the protrusions of the drive pulley and the driven pulley.

5. The belt-type transmission according to claim 1., wherein the tensioner has a width larger than an inner width of the belt before the tensioner is arranged inside and in contact with the belt.

6. The belt-type transmission according to claim 1, wherein the tensioner is made of elastic material.

7. The belt-type transmission according to claim 5, wherein the tensioner is made of elastic material.

8. The belt-type transmission according to claim 7, wherein the tensioner is made of plastic.

9. An electric power steering apparatus of an automobile comprising:
a pinion shaft connected to a steering wheel of the vehicle, and having a pinion gear formed on one end;
a rack bar connected to both wheels of the vehicle, and having a rack gear formed in one end portion to mesh with the pinion gear and a ball screw formed in the other end portion;
a motor for generating steering power in proportion to steering torque generated by the steering wheel;
a motor pulley coupled with a motor shaft of the motor;
a ball nut meshing with the ball screw of the rack bar via a ball;
a ball nut pulley provided on an outer periphery of the ball nut;
a belt connecting the motor pulley to the ball nut pulley; and
a tensioner arranged inside and in contact with the belt.

10. The electric power steering apparatus according to claim 9, wherein the motor pulley has protrusions on an outer periphery.

11. The electric power steering apparatus according to claim 10, wherein the ball nut pulley has protrusions on an outer periphery, the protrusions of the ball nut pulley being configured an identical way to the protrusions of the motor pulley.

12. The electric power steering apparatus according to claim 11, wherein the belt has protrusions on an inner periphery, meshing with the protrusions of the motor pulley and the ball nut pulley.

13. The electric power steering apparatus according to claim 9, wherein the tensioner has a width larger than an inner width of the belt before the tensioner is arranged inside and in contact with the belt.

14. The electric power steering apparatus according to claim 9, wherein the tensioner is made of elastic material.

15. The electric power steering apparatus according to claim 13, wherein the tensioner is made of elastic material.

16. The electric power steering apparatus according to claim 15, wherein the tensioner is made of plastic.
